(19) United States
(12) Patent Application Publication
(10) Pub. No.: US 2010/0325228 A1
(43) Pub. Date: Dec. 23, 2010

(54) Systems and methods for distributed activity management system

(76) Inventor: Alon Novy, Palo Alto, CA (US)

Correspondence Address: Goodwin Procter LLP;Attn: Patent Administrator, 135 Commonwealth Drive, Menlo Park, CA, 94025-1105, US

(21) Appl. No.: 12/820,857

(22) Filed: Jun. 22, 2010

Related U.S. Application Data
(60) Provisional application No. 61/219,620, filed on Jun. 23, 2009.

(51) Int. Cl. G06F 15/16

(52) U.S. Cl. 709/206

(57) ABSTRACT

A new approach is proposed that contemplates systems and methods to support context-sensitive presentation of activity management data. Under the approach, a user's current activities are monitored and relevant data in a computer-based activity management system is retrieved if the monitored user activities meet certain criteria. A signal is then provided to the user indicative of the existence of data in the computer-based activity management system relevant to the current work of the user. Once the user indicates his/her intent to access such relevant data, that data is made accessible to the user.

### RELATED APPLICATIONS

This application claims the benefit of U.S. Provisional Patent Application No. 61/219,620, filed Jun. 23, 2009, and entitled “Systems and methods for distributed activity management system,” by Alon Novy, and is fully incorporated herein by reference.

This application is related to U.S. Pat. No. 7,669,138, filed Oct. 27, 2006, and entitled “Interacting with a computer-based management system,” by Alon Novy, which is hereby incorporated herein by reference.

This application is related to U.S. patent application Ser. No. 11/457,873, filed Jul. 17, 2006, and entitled “Method and apparatus for providing structured data for free text messages,” by Alon Novy, and which is hereby incorporated herein by reference.

### BACKGROUND

There exist computer-implemented systems for managing the activities of one or more persons (collectively “Activity Management Systems”). Electronic To-do lists, issue management systems, project management systems and calendaring systems are all examples of such Activity Management Systems. Activity Management Systems include personal systems, server-based group systems and distributed systems. Here, personal systems are intended for use by a single user only, and typically do not provide a direct means of sharing data with other users and keeping that shared data up-to-date for all users. Exemplary personal data systems include many to-do list products. Server-based group systems provide for the aggregation of activity data concerning a group of persons, and typically require the use of a central server where the aggregated data is maintained. Microsoft Project Server and Primavera are two popular examples.

Also known are systems that to varying degrees do not require a central server, yet provide for the sharing of activity data. Among the best known are calendaring systems, wherein users are able to issue invitations to meetings and appointments by means of a composite data message, typically implemented by means of a specially formatted email, the email comprising structured data to describe the meeting and the attendees, and optionally some free-text. Typically both the sender and the receiving user will each have a copy of the appointment stored in a personal database, e.g., a Microsoft Outlook offline file and/or Microsoft Exchange Mailbox. One aspect of the distributed systems is that they do not require the use of a central database accessible to all users.

Clearly the ability to share data concerning joint work is of considerable benefit to users. Personal systems do not provide this benefit at all. Server-based group systems do provide this benefit but are plagued by several serious issues. Implementing, securing and maintaining a central server accessible to many parties is often a non-trivial exercise requiring a variety of technical skills. Particularly where the intent is that the data is shared not just among the staff members of a single organization, but across the staff of two or more organizations. Firewalls often block external access to servers, the identities and security profiles for external users need to be defined, established and maintained and so on.

Furthermore, such server-based systems frequently allow only a single configuration for all participants. For example there is a pre-defined set of statuses assignable to tasks recorded in the system. The configuration may not suit all users. Finally, server-based solutions are often the subject of political disputes between users, where common exemplary disputes involve disagreements over who pays for the server, who holds responsibility for managing/maintaining the server and who ultimately owns the data held on the server.

Distributed systems do not require a central server to share data, and therefore overcome some of the issues and limitations typical of server based solutions. Yet existing distributed Activity Management Systems also have serious limitations. For one, it is typical of such systems that individual activities (e.g., a work assignment, an issue resolution) is associated (“tagged”) with descriptive data entities (“Tags”), from a predetermined available set of Tags. Examples of such descriptors include statuses, importance, and even Tags representing physical persons associated with the activity. Typically, the set of available tags referred to in the structured data must be known a priori by all clients if all clients are to intelligently process, group and/or respond to the activity management data. Consider a distributed calendaring system where one client sends an appointment to the other expecting one of 2 responses “Accepted”, and “Declined”. The responding client has a different configuration and supports a third status “Tentatively Accepted”. When the responding client sends a response marked “Tentatively Accepted” the first client will not have the means of correctly processing the received response.

This need for a priori knowledge of Tags is particularly troublesome in the case where the Tag is a user identity. Clearly in assigning critical work it important to have an unambiguous means of resolving identities to real-world persons. Yet if there is no central register for identities there is no easy mechanism by which structured data can refer to persons such that all clients who receive that structured data can unambiguously resolve the reference. Many systems today use the person's email address as a means of providing a unique identifier. Unfortunately, today many people maintain plurality of email addresses and in typical distributed systems there is no easy way of determining if two email addresses refer to the same physical person or two different persons. Thus there is a need for distributed Activity Management Systems that do not require exhaustive a priori knowledge of all Tags referred to in the structured data sent between clients from time to time.

Furthermore, typical distributed Activity Management Systems require update messages to be sent to all affected users when a first user makes a change to an entry in his/her database. There exists an unsatisfied need for distributed Activity Management Systems that automatically synchronize data between clients.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support distributed sharing of user identity and classification information.

FIG. 2 depicts a flowchart of an example of a process to support distributed sharing of user identity and classification information.

FIG. 3 depicts an example of to support composing a new composite data message.

FIG. 4 depicts an example of the manner data entities used to describe status of work assignments are decomposed hierarchically.

FIG. 5 depicts a flowchart of an example of a process to support sending composite data message with the user's interest registered in the user's personal database.

FIG. 6 depicts a flowchart of an example of a process to support receiving composite data message with the user's interest registered in the user's personal database.

FIG. 7 depicts a flowchart of an example of a process to support changing activity management data.

FIG. 8 depicts an example of to support processing a conventional response to a composite data message.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support distributed sharing of user identity and classification information. More specifically, a sender's principal identity is registered with at least one identity registry and alternate identities for the user are progressively collected and resolved. In addition, tags on the user's activities are classified such that handling and grouping decisions can be made by clients without exhaustive a priori knowledge of the data entities. Once classified, the principal and alternate identity information as well as the classification information is communicated to one or more recipients over a network. The composite data messages received by the recipients are then processed to retrieve and save the identity and classification information from the sender. The extracted identity and classification information is then used to automatically update data originally received.

In some embodiments, the proposed approach applies to a distributed activity management system, comprising one or more clients, each client maintaining a personal database of activity data sent or received by the client in the form of composite data messages, each such composite data message comprising free-text and structured data. Maintaining a local database further includes updating data based on synchronization information from a remote data source. The sending of composite data messages includes meta-data for use in handling and grouping data received from clients with different configurations.

In one embodiment the receiving of conventional free-text messages includes determining if the conventional free-text is a response from a conventional messaging client to a composite data message, and in this case re-integrating that response message as if it were a composite data message.

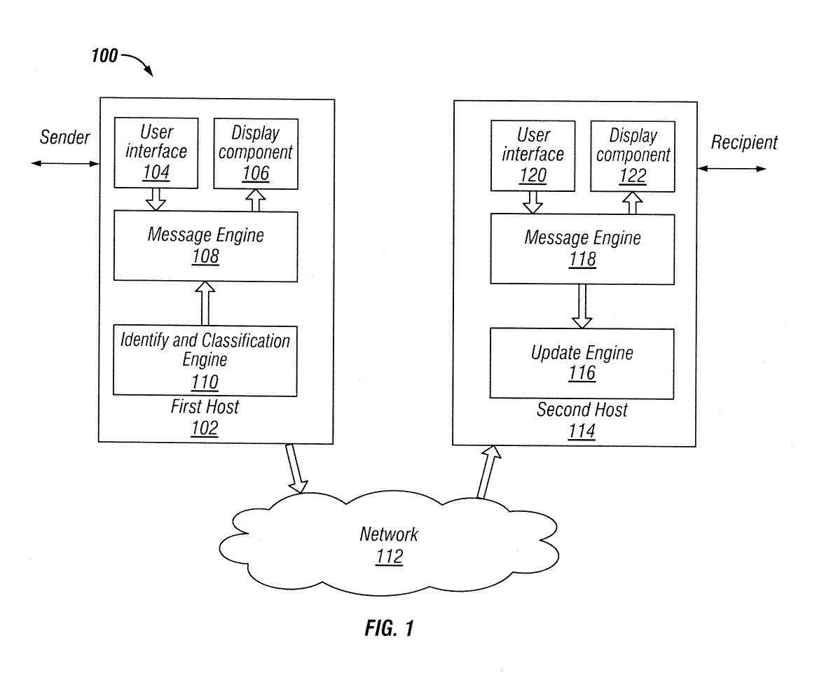

FIG. 1 depicts an example of a system diagram to support distributed sharing of user identity and classification information. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a first host (hosting device) 102 associated with a sender, wherein various engines and components running on host 102 include at least a user interface 104, a display component 106, a message engine 108, and a identity and classification engine 110; one or more second host 114 each associated with a recipient, wherein various engines and components running on host 114 include at least an update engine 116, a message engine 118, a user interface 120, and a display component 122; and a network 112.

As used herein, the term “engine” or “component” refers to a software, firmware, hardware, or other component that is used to effectuate a purpose. The engine, component, or bridge will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term database is used broadly to include any known or convenient means for storing data, whether centralized or distributed, relational or otherwise.

In the example of FIG. 1, each of the first host 102 and the second host 114 can be a computing device, a communication device, a storage device, or any electronic device capable of running a software component. For non-limiting examples, a computing device can be but is not limited to, a laptop PC, a desktop PC, a tablet PC, an iPod, an iPad, a PDA, or a server machine. A storage device can be but is not limited to a hard disk drive, a flash memory drive, or any portable storage device. A communication device can be but is not limited to a mobile phone.

In the example of FIG. 1, each of the first host 102 and the second host 114 has a communication interface (not shown), which is a software component that enables the hosts to communicate with each other following certain communication protocols, such as TCP/IP protocol. The communication protocols between two devices are well known to those of skill in the art.

In some embodiments, the first host 102 and the second host 114 can be identical, wherein the sender and the recipient are associated with the same host to send and receive messages. Under such a scenario, the heterogeneous messaging environment 112 becomes optional as the messages are exchanged with the sender and the recipient without passing through via a network.

As used herein, each message can be but is not limited to one of email, instant message, notice, Tweet, and other kinds of electronic message exchangeable between the sender and the recipients. In some embodiments, the message can be a composite data message comprising both free-text and structured data, which include but are limited to, pictures, documents, calendar invitations, electronic business cards, XML files, and other forms of structured data. Generating and sending composite data messages decreases the probability that recipients of the messages intentionally or unintentionally reduce the integrity of the structured data.

In some embodiments, the composite data message is in accordance with a activity data schema compatible with a computer-based activity management system as discussed in U.S. Pat. No. 7,669,138 and U.S. patent application Ser. No. 11/457,873. For the activity management system, the free-text portion of the composite data message is for providing activity information to at least one human recipient about an action the sender would like the recipient to carry out, and the structured data portion of the message is for providing new information and/or updates to the same and/or other activity management system(s) about the work assignment according to the activity data schema.

In the example of FIG. 1, the user interface 104 and 120 running on the first host 102 and the second host 114, respectively, enables the sender and the recipients to interact with the message engines 108 and 118 in order to read, compose, reply to, or forward the messages or perform other message-related operations. Such user interface can be Web-based browser for web-based messaging systems.

In the example of FIG. 1, the display components 106 and 122 of the first host 102 and the second host 114, respectively, enables the sender and the recipients to review the messages being drafted or composed or read the messages received. Here, each of the display components 110 and 122 can be a monitor, a screen, or any other displaying device associated with the hosts 102 and 114 known to one skilled in the art including the entire displayable desktop of the hosts.

In the example of FIG. 1, the message engines 108 and 118 running on the first host 102 and the second host 114, respectively, enables the sender and the recipients to read, compose, reply to, or forward the messages or perform other message-related operations. In some embodiments, each message engine can be an email client application, which can be but is not limited to Microsoft Outlook running under a Microsoft Windows operating system, Mail running under Mac OS, or an email client under Linux operating system, wherein the email client application communicates with an email server such as Microsoft Exchange to send and receive messages to and from other email client applications. Alternatively, each message engine can be a Web-based email client, such as Yahoo Mail, Hotmail, Gmail, or AOL Mail, that are accessible via a Web browser, wherein such Web-based email client communicates to Web-based email servers over a network.

In the example of FIG. 1, the first host 102 and the second host 114 communicate and interact with each other via network 112. Here, network 112 can be a communication network based on certain communication protocols, such as TCP/IP protocol. Such network can be but is not limited to, internet, intranet, wide area network (WAN), local area network (LAN), wireless network, Bluetooth, WiFi, and mobile communication network. The physical connections of the network and the communication protocols are well known to those of skill in the art.

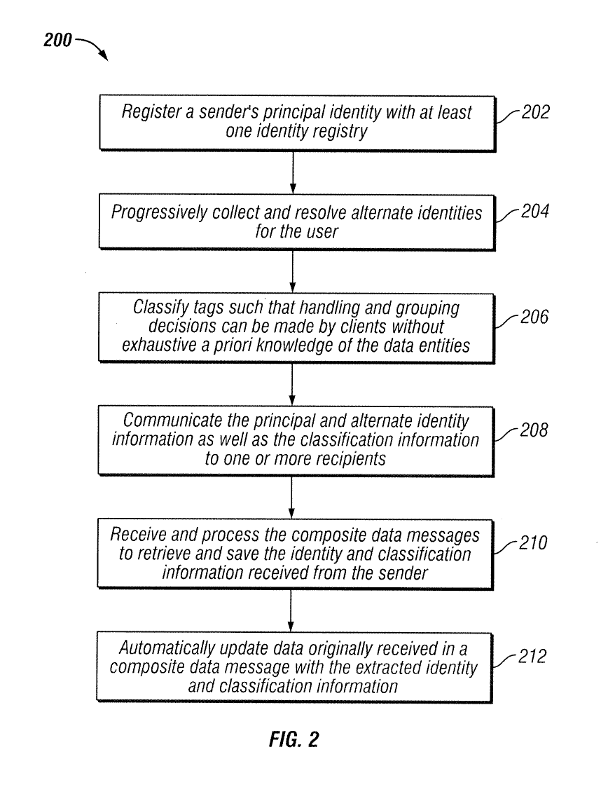

FIG. 2 depicts a flowchart of an example of a process to support distributed sharing of user identity and classification information. Although, this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202 where identity and classification engine 110 running on the first host 102 registers a sender/user's principal identity with at least one identity registry. The flowchart 200 continues to block 204 where identity and classification engine 110 progressively collects and resolves alternate identities for the user. The flowchart 200 continues to block 206 where identity and classification engine 110 classifies tags such that handling and grouping decisions can be made by clients without exhaustive a priori knowledge of the data entities.

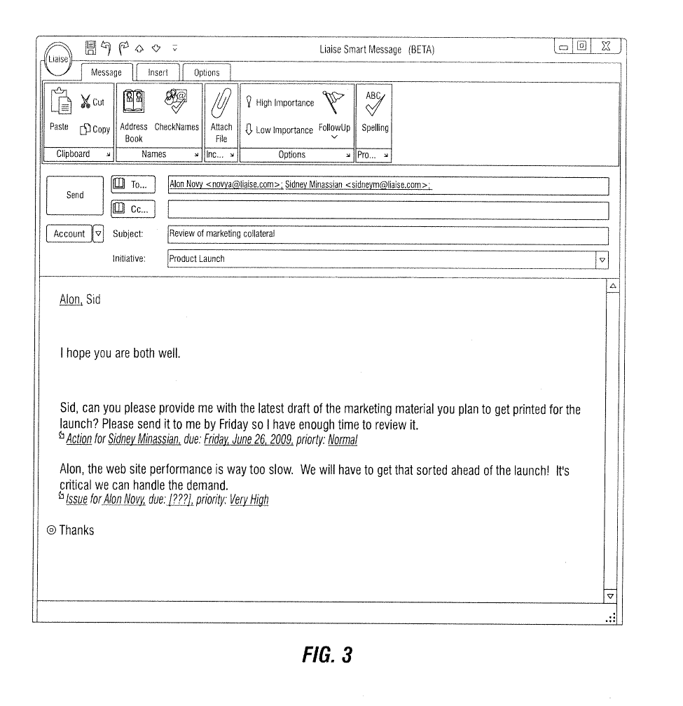

The flowchart 200 continues to block 208 where message engine 108 running on first host 102 communicates the principal and alternate identity information as well as the classification information to one or more recipients over network 112, wherein the communicating is done by means of composite data messages. FIG. 3 depicts an example of to support composing a new composite data message.

The flowchart 200 continues to block 210 where message engine 118 running on second host 114 receives and processes the composite data messages to retrieve and save the identity and classification information received from the sender. The flowchart 200 ends at block 212 where update engine 116 automatically updates data originally received in a composite data message with the extracted identity and classification information.

According to some embodiments the identity registry is implemented as a web server where users enter identifying information including a family name, a given name and a personal identifier. In one embodiment the personal identifier is the principal email address used by the user. The information captured in the identity registry becomes the principal identity of the user. According to one embodiment the principal identity information is emailed to the user as part of a verification step to ensure the user is actually the legitimate owner of the given email address. In one embodiment, receipt of the email is confirmed by means of clicking a hyperlink to a landing page. In one embodiment the principal identity is stored in the client's personal database.

Note that other embodiments exist, for example embodiments where the identity registry is not a web server but a central database accessed by means of a client-server interface. In yet other embodiments the registry is a web service accessed using SOAP.

In yet other embodiments the identifier for a person is not an email address. For example the identifier is a user-assignable login name or an automatically generated identifier such as a GUID.

In one embodiment, progressively collecting and resolving alternate identities for a user includes allowing the user to manually enter additional identities. In one embodiment the sending of composite data messages includes sending the principal identity and any alternate identity of the sender, as well as the principal and alternate identities of any persons referred to in the message, where the identities happen to be known in the sender's personal database. The processing of received composite data messages includes extracting the principal and alternate identities provided in the composite data message and storing these identities to the recipient's personal database(s). In some embodiments all when a principal identity becomes known in a personal database, this includes automatically updating any data in the database where the data is associated with any of that person's alternate identities such that that the data becomes associated with the newly received principal identity. In one embodiment associating data with a principal identity when it was previously associated with an alternate identity includes physically updating data in the personal database. In another embodiment, the database is not updated, but when data is retrieved for display and reporting purposes only the principal identity is used and data associated with the alternate identities is grouped with the principal identity's data.

Aside from person identity data, typical Activity Management Systems also provide a set of predetermined Tags for describing, grouping and instructing the handling of activity data such as Actions and Issues. Some exemplary Tags include statuses, e.g., “Open”, “Closed” and “For Review”, and importance classifiers e.g., “High”, “Medium” and “Low”. According to one aspect of the invention at least one universal classification scheme is provided for such predetermined Tags, thereby enabling clients to group and process activity data without a priori knowledge of every Tag in use by other clients.

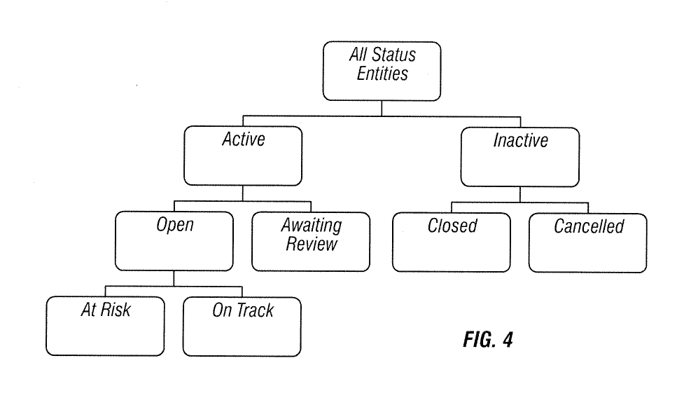

In some embodiments classifying Tags includes classifying them in accordance with a decomposition hierarchy, wherein the root classification(s) provide the broadest, most general classification and each level of decomposition providing a more granular division. In one embodiment the Tags used to describe status of work assignments are decomposed hierarchically in the manner as depicted in FIG. 4.

In one embodiment each classification in the decomposition has a unique identifier, e.g., a GUID. In one embodiment each client knows at least the “Active” and “Inactive” statuses and is able to handle work assignments at either status. Some clients also know additional, more granular statuses, e.g., “Open”. Some clients know even more granular statuses, e.g., “At Risk”. According to one embodiment when a client sends a composite data message, it sends for each classification all the super-classifications. In the case of statuses, a client might send a composite data message for a work assignment marked “At Risk”. In this case the composite data message includes information that shows “At Risk” to be a subset of “Open” which in turn is a subset of “Active”. In this way if the message is received by a client that does not recognize “at Risk” but which does recognize “Active” that client is able to process the received data as it would any item marked “Active”. Many alternate embodiments exist for a variety of classifications, for example Importance, and for software bug tracking systems, bug types.

In another embodiment classifications are further divided into private and public equivalents. For example the “At Risk” status may be a private status that is not for communicating to unauthorized persons. In this case when an item marked “At Risk” is communicated to an unauthorized person is converted to its public equivalent prior to being stored in the unauthorized person's database.

In some embodiments, instead of using a decomposition hierarchy for classifying Tags the embodiment provides meta-data assignable to Tags for the purpose of classifying Tags. For example, according to one such embodiment, the status meta data includes a set of Boolean values assignable to each status, e.g., IsActiveStatus, IsProblemStatus, IsReviewStatus for indicating whether or not a given status indicates that a given work assignment is active, at risk or at review respectively. In this embodiment, communicating composite data messages includes communicating the meta-data as part of the composite data message.

According to yet other embodiments at least one central registry is provided for registering Tags used by clients. In this embodiment clients are able to look up classifications for Tags from the one or more central registries. Many such embodiments exist, including embodiments wherein the central registry is a web server, a web services and/or a directly accessible database.

According to one embodiment processing received composite data messages includes saving the received activity management data to the receiving user's personal database, including any new user identities and other Tags. Additionally in one embodiment saving a new user identity includes reconciling information associated with alternate user identities with the corresponding principal user identity.

In some embodiments a Tag is a scalar value. In other embodiments a Tag is an object with structure, e.g., it comprises at least one data field.

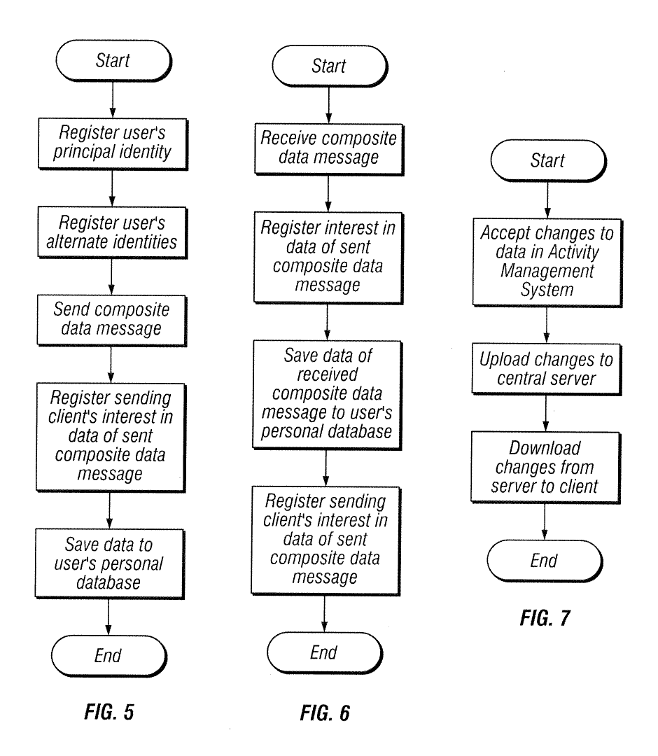

According to one embodiment changes to activity data stored in any personal database in the distributed activity management system are uploaded to a central server. On sending and receiving new activity management data by means of a composite data message, clients provide a signal to the server registering the client's interest in the communicated activity management data. The server provides a means for clients with registered interest in a given activity management data to download the latest change and/or state. FIG. 5 depicts a flowchart of an example of a process to support sending composite data message with the user's interest registered in the user's personal database. FIG. 6 depicts a flowchart of an example of a process to support receiving composite data message with the user's interest registered in the user's personal database.

According to one embodiment clients poll the server for changes in data periodically, and, in the case that changes are available, download these changes and/or the latest state of the changed activity management data. In another embodiment the server signals the clients with registered interest in the changed activity management data and clients respond to the signal by downloading the changed data and/or state. FIG. 7 depicts a flowchart of an example of a process to support changing activity management data.

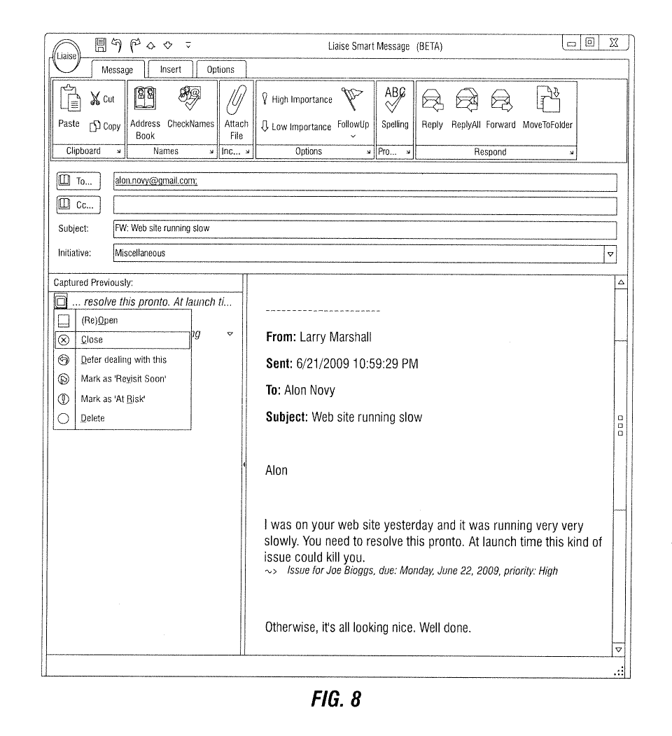

In some cases it is possible that a composite data message is sent to another messaging system, e.g., another email client, that does not implement an embodiment of the present invention, and the user of that other messaging system respond to that message by generating a conventional response (reply or forward) message such that the response is received by a client that does implement an embodiment of the invention. According to some embodiments the client determines that the conventional message is a response to a composite data message and saves the response to the user's personal database as a response to the original composite data message. FIG. 8 depicts an example of to support processing a conventional response to a composite data message.

In one such embodiment determining that the conventional message is a response to a composite data message includes parsing the message header to discover at least one reference to the original composite data message.

In one embodiment determining that the conventional message is a response to a composite data message includes parsing the message subject or body for at least one reference to the original composite data message.

In one embodiment determining that the conventional message is a response to a composite data message includes parsing message attachments for at least one reference to the original composite data message.

In some embodiments generating the original composite data message includes embedded such references to the composite data message as are likely to be re-included by conventional messaging systems when generating a response to the composite data message. For example, embedding the reference in at least one of the subject, the body, the header and an attachment of the composite data message.

In one embodiment the composite data messages are generated with embedded attachments that bear a high likelihood of being re-included in response messages generated by conventional messaging systems.

In one embodiment processing conventional messages received in response to a composite data message includes optionally providing the user with a means to add and/or edit associated structured data. In one embodiment a text understanding system is used to help generate structured data.

Some embodiments include clients which save activity management data to a central shared database, in addition to and/or instead of a personal database.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

1. A system, comprising:
an identity and classification engine running on a first host associated with a sender, which in operation,
registers a sender's principal identity with at least one identity registry;
progressively collects and resolves alternate identities for the user;
classifies tags such that handling and grouping decisions can be made by clients without exhaustive a priori knowledge of the data entities
a first message engine running on the first host, which in operation, communicates the principal and alternate identity information as well as the classification information to one or more recipients;
a second message engine running on a second host associated with one of the recipients, which in operation, receive and process the composite data messages to retrieve and save the identity and classification information received from the sender;
an update engine running on the second host, which in operation, automatically update data originally received in a composite data message with the extracted identity and classification information.

2. A computer-implemented method, comprising:
registering a sender's principal identity with at least one identity registry;
progressively collecting and resolving alternate identities for the user;
classifying tags such that handling and grouping decisions can be made by clients without exhaustive a priori knowledge of the data entities;
communicating the principal and alternate identity information as well as the classification information to one or more recipients;
receiving and processing the composite data messages to retrieve and save the identity and classification information received from the sender;
automatically updating data originally received in a composite data message with the extracted identity and classification information.

3. A machine readable medium having software instructions stored thereon that when executed cause a system to:
register a sender's principal identity with at least one identity registry;
progressively collect and resolve alternate identities for the user;
classify tags such that handling and grouping decisions can be made by clients without exhaustive a priori knowledge of the data entities;
communicate the principal and alternate identity information as well as the classification information to one or more recipients;
receive and process the composite data messages to retrieve and save the identity and classification information received from the sender;
automatically update data originally received in a composite data message with the extracted identity and classification information.
